(19) United States
(12) Patent Application Publication
(10) Pub. No.: US 2014/0003279 A1
(43) Pub. Date: Jan. 2, 2014

(54) UPLINK TIMING RECOVERY

(71) Applicant: Weili Ren, Tokyo (JP)

(72) Inventor: Weili Ren, Tokyo (JP)

(73) Assignee: NEC CORPORATION, Tokyo (JP)

(21) Appl. No.: 14/017,551

(22) Filed: Sep. 4, 2013

Related U.S. Application Data
(63) Continuation of application No. 12/451,197, filed on Oct. 30, 2009.

(30) Foreign Application Priority Data
May 1, 2007 (GB) 0708399.1

(51) Int. Cl. H04W 72/04

(52) U.S. Cl. CPC H04W 72/0446
USPC 370/252; 370/328

(57) ABSTRACT

A method of controlling an uplink timing recovery within a mobile radio communications device operating within a mobile radio communications network includes determining a requirement for the uplink timing recovery in a manner responsive to a velocity of a movement of the mobile radio communications device, in which a determination of the velocity of the movement of the mobile radio communications device is achieved by a determination of a timing offset within downlink signaling.

The present application is a Continuation Application of U.S. patent application Ser. No. 12/451,197, filed on Oct. 30, 2009, which is based on International Application No. PCT/JP2008/058300, filed on Apr. 23, 2008, which is based on the United Kingdom Patent Application No. 0708399.1, the entire contents of which are incorporated herein by reference.

The present invention relates to a method of controlling uplink timing recovery within a mobile radio communications device operating within a mobile radio communications network, and to a related mobile radio communications device.

When operating within a mobile radio communications network, mobile radio communications device User Equipment (UE) requires synchronized operation with regard to signalling arriving from the network and this, in some embodiments such as within proposed Long Term Evolution (LTE) systems may require that Uplink (UL) timing signalling, in addition to current Timing Advance (TA) signalling remain valid.

Should such aforementioned UL timing, or indeed the current TA, become invalid, or indeed it becoming suspected that the UL timing and TA values have become invalid, a UL timing recovery operation is required in order to establish a correct TA value prior to any subsequent between the UE and the network.

In further detail, and referring particularly to an LTE example, when in an LTE_ACTIVE state, after a long time period during which no data has been transferred between an UE and the eNodeB(eNB), the UE may lose the UL timing, and so the current TA may become invalid due to the UE mobility. Then, when the UE has further data to transmit to the eNB such as after an inactive, or sleep period it is necessary to determine whether or not the current TA is still valid. If validity is suspect, the UE has to perform an UL timing recovery operation to regain the correct TA prior to new transmission. Similarly, when the eNB has data to transmit to the UE after an inactive period it has to determine if the UE still retains the UL timing value. If the value is not retained, the eNB must initiate a UL timing recovery operation for the UE to regain the correct TA.

Some proposals presented in recent 3GPP RAN1 and RAN2 meetings suggest that UE can perform periodic update of UL timing to maintain UL synchronization throughout LTE_ACTIVE state in order to minimize latency of data transmission resumption. Such proposals state that periodic update of UL timing is appropriate for real time services, i.e. delay sensitive services. This periodic update of UL timing requires the eNB periodically to allocate UL-SCH resources to the UE. The update rate is to be calculated based on the fastest UE speed supported in LTE with the permitted maximum TA inaccuracy.

However, it has also been shown that real time services, such as VoIP can automatically keep the UL synchronized by regular and periodic data transmission and so in such scenarios the periodic update of UL timing may unnecessarily waste precious radio resources.

Further known proposals suggest that the UE be allowed to lose UL timing, especially for non real time services, and regain it when transmission resumes in order to minimize use of radio resources. These proposals suggest timer-based UL timing recovery in which a timer is set in the UE and the eNB. When the timer expires, both the UE and the eNB determine that the UE has lost UL timing, and the current TA has become invalid.

It should of course be appreciated that UL timing recovery requires control signalling between the UE and the eNB and this, in turn, will lead to a signalling overhead and latency of transmission resumption. Typically, the UL timing recovery operation can include the following three steps for DL transmission resumption: first, the eNB transmits a request for transmission of “UL synch request” over L1/L2 control channel; secondly the UE sends a UL sync request over non-sync and contention-free RACH; and thirdly the eNB responds with the TA value

For UL transmission resumption, the operation may include: first the UE sending a UL sync request over non-sync and contention-based RACH; secondly the eNB allocating a UL-SCH grant with TA; and UE signals its C-RNTI with a buffer status report.

Indeed, it can be seen that timer-based UL timing recovery procedures can prove particularly disadvantageous. A timeout value needs to be determined for the timer, and this is set having regard to the worst case scenario in which the UE is moving at the fastest speed that is supported in LTE. For example if a TA accuracy of 0.5 μs is permitted, the timeout value could be as short as 0.54 s at a UE speed of 500 km/h. In reality, most UEs in a cell actually move far more slowly than 500 km/h Such a timer-based recovery mechanism therefore has many recovery operations unnecessarily performed while the UL timing is still valid and these unnecessary recovery operations disadvantageously incur signalling overhead, increase latency of transmission resumption and waste radio resources.

The present invention seeks to provide for a method for controlling uplink timing recovery within a mobile radio communications device, and to such a mobile radio communications device, having advantages over known such methods and devices.

According to a first aspect of the present invention there is provided a method of controlling uplink timing recovery within a mobile radio communications device operating within a mobile radio communications network, the method including the step of determining a requirement for uplink timing recovery in a manner responsive to velocity of movement of the mobile radio communications device.

Advantageously, and insofar as the determination of whether a loss of uplink timing has occurred is inherently velocity-dependent, the invention can ensure that an uplink timing operation is performed only when there is a high degree of certainty that the current Timing Advance is invalid, and further in a manner avoiding unnecessary recovery operations and minimizing signalling overhead.

Preferably, the determination of the velocity of the handset is achieved by way of determination of a timing-offset within downlink signalling.

In a particular embodiment, the mobile radio communications device is arranged to measure downlink reference signals in order to identify the said timing offset.

As will be appreciated, within the method of the present invention, the timing offset can be arranged as an indication of a change in timing advance.

The method can be provided such that the magnitude of the offset is taken to represent 50% of the magnitude of the change in the Timing Advance value.

The method further includes the step of comparing the said timing offset with a threshold value.

In particular, the threshold value can be broadcast from the network to the mobile radio communications device within a BCH.

As an alternative, the said threshold value can be delivered to the mobile radio communications device during Radio Resource Control (RRC) establishment.

Yet further, the method can include the step of generating an indication of UL timing loss at the mobile radio communications device.

The aforementioned indication, which may comprise a signalling flag, and can be sent to the network.

In one arrangement, the method can be provided whilst the mobile radio communications device is within a continuous reception (RX) mode.

Also, as an alternative, the method can be provided while the mobile radio communications devices are operating within a discontinuous reception (DRX) mode.

According to another aspect of the present invention there is provided a mobile radio communications device for operation within a mobile radio communications network and including means arranged to control uplink timing recovery, the said means being arranged to determine a requirement for uplink timing recovery responsive to velocity of movement of the device.

Again, insofar as the determination of whether a loss of uplink timing has occurred is inherently velocity-dependent and so the invention can ensure that an uplink timing operation is performed in a manner avoiding unnecessary recovery operations and minimizing signalling overhead.

Preferably, the device is arranged such that the determination of the velocity of the handset can be achieved by way of determination of a timing-offset within downlink signalling.

The mobile radio communications device can be arranged to measure downlink reference signals in order to identify the said timing offset.

As with the method of the present invention noted above, the timing offset serves as an indication of a change in timing advance.

The device is further arranged to compare the said timing offset with a threshold value.

In particular, the mobile radio communications device can be arranged to receive the threshold value within a BCH.

As an alternative, the device is arranged to receive the threshold value during Radio Resource Control (RRC) establishment.

The device can further be arranged to provide an indication of uplink timing loss and which may comprise a signalling flag that can be sent to the network.

As will therefore be appreciated, the present invention can provide for a new technique for a UE to determine the validity of the UL timing after an inactive or sleeping period of time. Such determination can be based on the measured timing offset of DL RS1 (downlink reference signal 1), which is detected by the UE, regularly in continuous RX mode or upon wake-up in DRX mode. Over a certain period of time, the timing offset of DL RS1 is pretty much caused by the UE mobility, and its magnitude is dependent on the UE velocity. The timing offset of DL RS1 caused by UE mobility is considered to be half of, in magnitude, the change of the TA value. When the timing offset DL RS1 caused by UE mobility is considered to be half of, in magnitude, the change of the TA value. When the timing offset DL RS1 is determined to be sufficiently large, i.e. it exceeds a threshold value, UE determines that UL timing has been lost. A flag is then set to indicate such a loss of UL timing and the flag can be sent to the eNB. As noted, the invention advantageously relates to indirectly render the determination of UL timing-loss responsive to UE velocity. UL timing recovery need only then be performed prior to any new data transmission. The determination of UL timing loss can be based on the measured timing offset of DL RS1 since this is inherently UE velocity dependent. This ensures that a UL timing recovery operation is performed only when the current TA has become invalid.

The invention is described further hereinafter, by way of example only, with reference to the accompanying drawings in which:

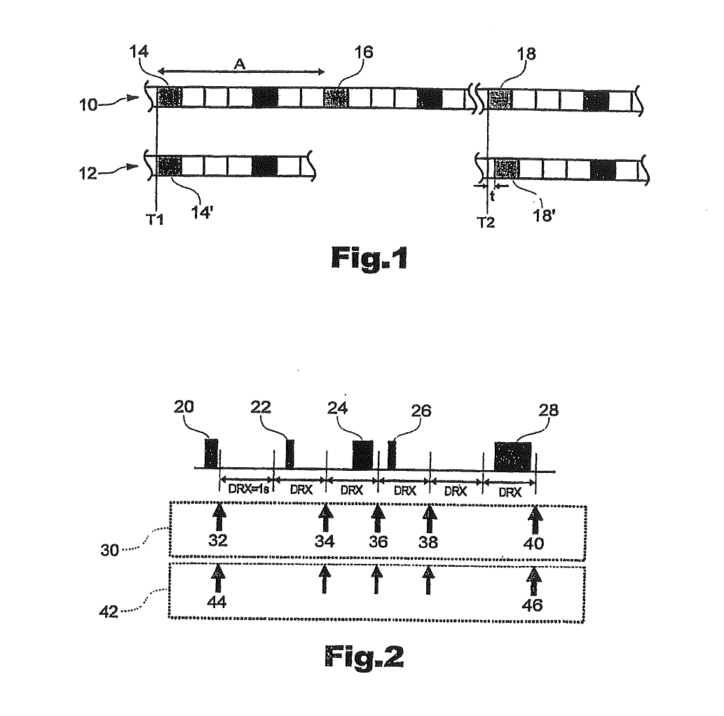

FIG. 1 is a relative timing diagram illustrating the transmission and reception of downlink reference signals as employed in accordance with an embodiment of the present invention;

FIG. 2 is a comparative timing diagram illustrating uplink timing recovery as arising in the current art, and in accordance with an embodiment of the present invention;

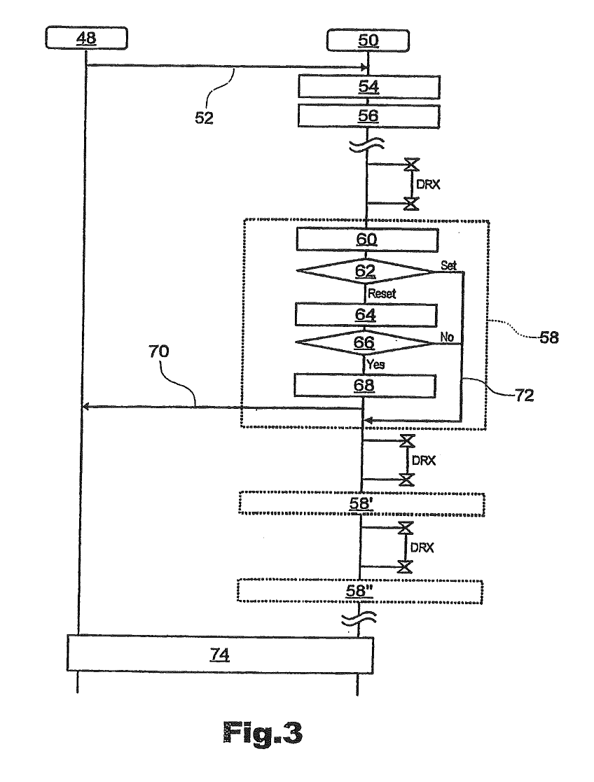

FIG. 3 is a signalling diagram illustrating an embodiment of the present invention when implemented within a mobile radio communications device operated within a discontinuous reception mode; and

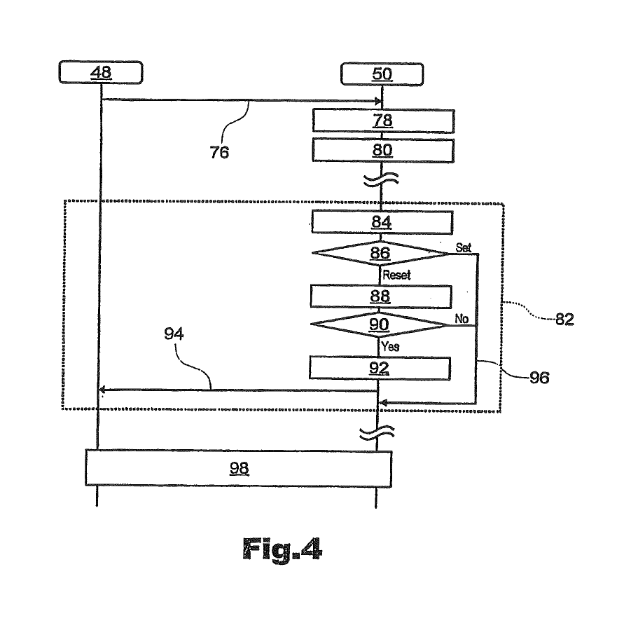

FIG. 4 is a similar signalling diagram to that of FIG. 3 but illustrating an embodiment of the present invention for a mobile radio communications device operating within a continuous reception mode.

Turning first to FIG. 1, there is illustrated a timing diagram comprising time instance T1 and T2 at which a downlink reference signal 10 is transmitted from an eNodeB of a LTE network to a UE device and as received 12 at a UE device. Timing point T1 arises when the UE receives a TA from the network.

As illustrated, within the transmitted signal 10 there is a series of reference signal blocks 14, 16, 18 separated by a sub-frame having a size indicated by arrow A.

The same reference signal blocks and sub-frames are received at the UE as illustrated by reference signal blocks 14′18′ within received signalling 12.

However at the time T2 of receipt of the reference signal 18′ at the UE, a timing offset value indicated by arrows t has been introduced as illustrated.

In LTE, the UE regularly measures DL RS (downlink reference signals) for DL channel estimation and Channel Quality Indication (CQI) reporting etc in continuous RX mode. When the UE activity level decreases the eNB may put the UE into its DRX mode for improved power consumption performance. In LTE_ACTIVE DRX mode, the UE wakes up at the end of each DRX period, and measures DL RS for DL timing updating, channel estimation and CQI reporting for possible data reception

As a result of basic measurement of DL RS1, the UE detects DL timing offset, as shown in FIG. 1. Over a certain amount of time, the timing offset of DL RS1 is generally caused by the UE mobility, and its magnitude is dependent on the UE velocity. The greater the UE velocity, the greater the timing offset of RS1. The timing offset of RS1 caused by UE mobility is half of, in magnitude, the change in the actual TA, if minor delay spread difference in UL and DL caused by different frequency bands is considered to be negligible. When the timing offset of RS1 is determined to be large enough to exceed a threshold value, the UE judges that it has lost UL timing, such that the TA last received from the eNB has become invalid. The flag to indicate UL timing loss is set and sent to the eNB. After that, UL timing recovery needs to be performed prior to any new data transmission in DL or UL.

In the particular example, if accurate timing offset caused only by UE mobility can be detected, half of the permitted TA accuracy can be used as the above-mentioned threshold. Of course, if measurement on the timing offset might unavoidably contain some error, a value of less than half of the permitted TA accuracy could be used. In further detail, if TA accuracy of 0.5 μs is assumed as an example, and with a corresponding one-way propagation distance variation of 75 meters, It will take a different amount of time for UEs moving at different velocities to move beyond this distance limit. For example, a UE will take 0.5 s at velocity of 500 km/h; 2.3 s at a velocity of 120 km/h; and 5.4 s at a velocity of 50 km/h. The determination of the offset, and this TA validity, become velocity dependent.

As will therefore be appreciated, the present invention does not require that the UE perform any specific further measurement in order to function, since it can simply make use of existing measurements to obtain the timing offset of RS1. Therefore the invention can offer the benefit of removing all unnecessary recovery operations and minimizing signalling overhead at no further operational expense.

Yet further, the proposed method can tolerate, to a great extent, an inaccuracy of measured RS1 timing offset, (which could be caused by an abrupt change of delay spread profile), and the difference between the RS1 timing offset and the 50% change in TA, (which could happen since UL and DL channels may experience slightly different delay spread profile in different frequency bands). For example, if the measured RS1 timing offset has for example a ±20% error serving to reflect the actual TA change, it just becomes necessary to reduce the threshold from half of the permitted TA accuracy Tₚ/2 to Tp/(2*(1+0.2)) for appropriate use of the present invention.

Turning now to FIG. 2, there is provided a comparative timing diagram concerning the manner in which data blocks buffered within an eNB within a network are handled with regard to UL timing recovery both in relation to an example of the current art, and in example of the present invention.

Within FIG. 2, there is illustrated a plurality of buffered data blocks 20-28 and a series of discontinuous reception periods DRX, each of which has a magnitude of 1 s.

Turning first to UL recovery pattern 30 employing a currently known timer-based UL timer recovery arrangement, it will be appreciated that five separate UL timer recovery instances 32-40 are illustrated whereas, within arrangement 42 embodying the present invention, only two such UL timing recovery instances 44, 46 are required. As explained further below, this arises since new data block 22, 24 and 26 completes its transmissions without requiring UL timing recovery since the currently occurring TA value remains valid.

Within FIG. 2, a web-browsing service with the UE in LTE_ACTIVE DRX mode comprises the basis for the illustration. A value of between one and a few seconds is likely to be used for DRX periods setting in web-browsing service though much longer silent periods usually exist. If TA accuracy of 0.5 μs is permitted, and DRX period is set 1 s, each new transmission that occurs at end of DRX period needs UL timing recovery operation in the timer-based method 30 no matter how slowly the UE is moving. With the illustrated embodiment 42 of the invention, even if the UE is moving at speeds experienced on main roads and motorways, e.g. 120 km/h, only new transmissions at the end of two DRXs will require a recovery operation.

Turning now to FIG. 3, there is provided a signalling diagram serving to illustrate an implementation of the present invention with regard to signalling between an eNB 48 and related UE 50 when operating within an LTE_ACTIVE discontinuous reception mode.

Additionally, a current TA value is provided from the eNodeB 48 to the UE 50 by way of L1/2 signalling 52. Within the UE 50, this serves at 54 to reset at 56 any previous flag indicating UL timing loss.

The UE 50 then continues within its discontinuous reception mode for a discontinuous reception period DRX with 58 determination as to whether UL timing loss has occurred.

As will be appreciated from FIG. 3, subsequent determinations 58′, 58″ are also illustrated and as separated by further discontinuous reception periods DRX.

Only the determination block 58 is illustrated in detail and it will be appreciated there that the first step 60 is derived from measurement of the downlink reference signal DL-RS1 and an associated determination as to whether any drift in that signal has occurred.

At step 62 it is determined whether or not the UL timing loss flag has already been set. Assuming that the determination at 62 indicates that the flag has been reset, the procedure continues to step 64 to determine whether or not offset value t is equivalent to a combination of the offset value t and the aforementioned drift in the DL-RS1 signal.

Subsequently at step 66, is determined whether or not the offset value t is greater than a predetermined threshold.

If it is found at step 66 that the offset value t is greater than the threshold, then the UE 50 is arranged to set a flag indicating UL timing loss at 68 which can subsequently be indicated to the eNodeB 48 via non-synchronized RACH signalling 70.

Remaining with the determination block 58, if at step 62 it is determined that a UL timing flag has already been set, and that at step 66 it is determined that the offset value t is less than the threshold value, then the procedure continues via route 72 and subsequently onwards to the next discontinuous reception DRX eriod.

When transmission resumes at 74, UL timing recovery can then be performed as previously required by the flag within signalling 70.

Turning lastly to FIG. 4, there is illustrated further signalling between an eNodeB 48 and UE 50 and which again commences with the provision of a current timing advance value by way of layer L1/2 signalling 76 from the eNodeB 48 to the UE 50. FIG. 4 illustrates operation of UE 50 within a continuous reception mode.

As with the illustration of FIG. 3, the implementation follows the initial steps of resetting off-set value t at step 78, and subsequently resetting UL timing loss flag at step 80.

Then, a regular determination is performed one of which is illustrated at 82, as to whether the measured signal offset serves to indicate a particular likely velocity of movement of the UE 50. This measurement can be performed regularly at the same time as the general measurement of the DL-RS1 signal.

Within determination block 82, the DL-RS1 signal is measured at step 84 along with the determination of any signal drift and, at step 86, it is determined whether or not a UL timing loss flag has already been set.

Assuming at 86 is determined that the flag is currently reset, the procedure continues to step 88 to identify whether the offset value t is equivalent to a combination of the offset value and the aforementioned drift.

The procedure then continues to step 90 where it is determined whether or not the offset value t is greater than a predetermined threshold value and, if it is, at step 92 the flag indicating the timing loss is set and subsequently transmitted eNodeB 48 via non-synchronous RACH signalling 94.

Therefore again, if at step 86 it is determined that the UL timing loss flag is already set, or at step 90 it is determined that the offset value t is less than the predetermined threshold, the procedure continues via route 96 for subsequent performance of the DL-RS1 measurement.

When, as illustrated at 98, transmission is next to resume, and the processing as illustrated within block 82 indicates that UL timing has been lost, UL timing recovery can be performed as required and then followed subsequently by the required transmission.

As before, the DL timing offset is used to judge the validity of the current TA, and thus whether or not the UE has lost UL timing after an inactive period of time. The DL timing offset corresponds to change of the UE propagation distance that is caused by the UE mobility, and so as mentioned the proposed judgment of validity of UL timing is inherently UE velocity dependent.

1. A method of controlling an uplink timing recovery within a mobile radio communications device operating within a mobile radio communications network, said method including:
determining a requirement for the uplink timing recovery in a manner responsive to a velocity of a movement of the mobile radio communications device.

2. A method as claimed in claim 1, wherein a determination of the velocity of the movement of the mobile radio communications device is achieved by way of a determination of a timing offset within downlink signaling.

3. A method as claimed in claim 2, further including:
measuring a downlink reference signal in order to identify the timing offset.

4. A method as claimed in claim 3, wherein the timing offset serves as an indication of a change in a timing advance.

5. A method as claimed in claim 4, wherein the timing offset corresponds to 50% of a magnitude of the change in the timing advance.

6. A method as claimed in claim 1, further including:
comparing the timing offset with a threshold value.

7. A method as claimed in claim 6, wherein the threshold value is broadcast from the network to the mobile radio communications device within a BCH.

8. A method as claimed in claim 6, wherein the threshold value is delivered to the mobile radio communications device during a Radio Resource Control establishment.

9. A method as claimed in claim 1, further including:
generating an indication of an uplink timing loss at the mobile radio communications device.

10. A method as claimed in claim 9, wherein the indication comprises a signaling flag.

11. A method as claimed in claim 1, wherein the method is provided while the mobile radio communications device is within a continuous reception mode.

12. A method as claimed in claim 1, wherein the method is provided while the mobile radio communications device is operating within a discontinuous reception mode.

13. A mobile radio communications device for operation within a mobile radio communications network, said mobile radio communications device including:
a unit arranged to control an uplink timing recovery, the unit being arranged to determine a requirement for the uplink timing recovery responsive to a velocity of a movement of the mobile radio communications device.

14. A mobile radio communications device as claimed in claim 13, wherein a determination of the velocity of the movement of the mobile radio communications device is achieved by way of a determination of a timing offset within downlink signaling.

15. A mobile radio communications device as claimed in claim 14, wherein the mobile radio communications device is arranged to measure downlink reference signals in order to identify the timing offset.

16. A mobile radio communication device as claimed in claim 14, wherein the mobile radio communications device is arranged to compare the timing offset with a threshold value.

17. A mobile radio communications device as claimed in claim 13, wherein the mobile radio communications device is arranged to generate an indication of an uplink timing loss at the mobile radio communications device.

18. A method of controlling an uplink timing recovery within a mobile radio communications device operating within a mobile radio communications network, said method including:
determining a requirement for the uplink timing recovery in a manner responsive to a velocity of a movement of the mobile radio communications device.

19. The method of claim 18, wherein a determination of the velocity of the movement of the mobile radio communications device is achieved by a determination of a timing offset within downlink signaling.
